(19) United States
(12) Patent Application Publication
(10) Pub. No.: US 2026/0208976 A1
(43) Pub. Date: Jul. 23, 2026

(54) Clamping Apparatus for Holding a Container and Container Treatment Apparatus

(71) Applicant: KRONES AG, Neutraubling (DE)

(72) Inventors: Christian HOLZER, Neutraubling (DE); Sascha BAUER, Neutraubling (DE); Reiner GLOETZL, Neutraubling (DE); Michael SCHMID, Neutraubling (DE)

(73) Assignee: KRONES AG, NEUTRAUBLING (DE)

(21) Appl. No.: 19/157,315

(22) PCT Filed: Feb. 16, 2024
(86) PCT No.: PCT/EP2024/053963

§ 371 Date: Aug. 15, 2025

(30) Foreign Application Priority Data
Feb. 16, 2023 (DE) 10 2023 103 860.5

(51) Int. Cl. B65G 47/86; B65G 33/02; B65G 47/26

(52) U.S. Cl. CPC B65G 47/847; B65G 33/02; B65G 47/26

(57) ABSTRACT

The present invention relates to a clamping apparatus for holding a container in a container treatment apparatus, that includes a fixed clamping arm comprising a connection portion for connecting the clamping apparatus to a transport unit, for example a transport star, of a container treatment apparatus, wherein a pivotable clamping arm is arranged on the fixed clamping arm so as to be pivotable relative to the fixed clamping arm, wherein the pivotable clamping arm includes a control portion that is configured to interact with a position-specifying unit of the container treatment apparatus, in order to move the pivotable clamping arm between an opening position and a closing position; it further relates to a container treatment apparatus.

### CROSS REFERENCE TO RELATED APPLICATIONS

This application is a national stage of International Application No. PCT/EP2024/053963 filed Feb. 16, 2024, which claims priority from German Patent Application No. DE 10 2023 103 860.5 filed on Feb. 16, 2023, the disclosures of which are incorporated herein by reference in their entirety.

### BACKGROUND

### Technical Field

The present invention relates to a clamping apparatus for holding a container in a container treatment apparatus, for example an apparatus for filling bottles in a beverage filling plant. It also relates to a container treatment apparatus.

### Related Art

In beverage filling plants, it is known to hold the containers to be filled or already filled containers in each case by clamping apparatuses and in this way transport them through the individual treatment stations of the container treatment apparatus. In this case, different clamping apparatuses are known, which hold, in different ways, the respective containers to be treated.

For example, passive clamping apparatuses are known which are elastically preloaded simply by inserting the particular container into the clamping apparatus and then hold the particular container. Such a clamp for gripping containers is known from DE 10 2012 218 204 A1. In this case, the clamps have a fixed position. For gripping a container, the container must be pressed into the clamp. In this process, the stiff gripping arms are spread outwards so that the container must be moved against the closing force of the gripping arms resulting from the spreading of the clamp. As a result, the container is subjected to a high force during insertion, so that such holding apparatuses are not suitable for gripping or holding fragile and/or easily deformable and thin-walled containers. At least, there is a tendency to scratch the surfaces of the respective containers, so that the quality of the containers may be reduced.

Also known are active clamping apparatuses in which an opening and closing of the respective holding portions of the gripping apparatus is actively performed by an actuator. Active clamping apparatuses of this kind serve in particular to enable a secure and gentle take-over of the respective containers from a preceding clamping apparatus or to ensure an equally secure and container-friendly transfer of the containers to a subsequent clamping apparatus. In particular, through the active opening and closing of the respective clamping apparatus, an increased friction on the respective container, which could lead, for instance, to a scratching of the container, can be avoided and, on the other hand, a predefined holding force or clamping force, which can be maintained within a predefined tolerance range of the container dimension, can be set. Active clamping apparatuses of this kind are composed of a multitude of single parts, for instance clamping arms, bushings, spring elements, preloading elements, and corresponding connecting elements for securely connecting the aforementioned parts. Clamping apparatuses structured in this way are thus comparatively complex to clean and have a correspondingly high manufacturing outlay.

From EP 0 939 044 A1, a bottle gripper is known in which a clamping apparatus is provided, which has two gripping arms that can be brought into a holding position or a detaching position by a control cam. The control cam interacts with a contact surface configured on each gripping arm and the contact surface is configured as a component of an elastic cushion, which is arranged on the particular gripping arm.

In order to reduce the complexity of an active clamping apparatus and at the same time to make it possible for the clamping arms of the clamping apparatus to have a predefined position in a default state, for example a closed position, it is known to provide means on the clamping apparatus that apply a preloading to the clamping arms and thus preload the clamping arms into the predefined position.

From EP 2 143 674 A2, an active clamping apparatus for holding containers is known, in which two gripping arms or clamping arms are held in an open position with separate magnet arrangements. The clamping arms have rearward-facing locking levers that interact with a locking cam arranged between them, in order to move the clamping arms from the open position to a closed position.

DE 10 2005 014 838 A1 shows an active clamping apparatus for holding vessels with two clamping arms that are movable relative to one another for opening and closing. In order to ensure that the vessels are held securely, one gripping arm of the clamp is configured to be dimensionally stable and the other gripping arm is configured to be dimensionally elastic. The gripping arms are preloaded into an open position by magnets arranged on them and pivoted into the closed position by a control cam.

In principle, in conventional clamping apparatuses, which comprise preloading of the clamping arms into a predefined position, the clamping arms are in each case arranged to pivot about a pivot axis. In other words, the clamping arms of the clamping apparatus can be switched between an open position and a closed position by pivoting or rotating both clamping arms in each case. For closing the clamping apparatus, the clamping arms are pivoted or rotated about the axes of rotation in such a way that the holding portions of the clamping arms are rotated towards one another. Accordingly, for opening the clamp, the clamping arms and thus the holding portions must rotate away from one another.

In beverage filling plants, as a rule, a plurality of clamping apparatuses as described above are arranged on a carrier movable in a transport direction, for example a filler carousel, and can be removed from the carrier during a maintenance interval when components of the clamping apparatus, for example a clamping arm or a holding portion for holding a container of a clamping arm or a bearing bushing, are worn, in order to make the replacement of the clamping apparatus or the worn components possible.

Alternatively, it is known to configure the carrier of a container treatment apparatus, for example a rotary filler for filling containers with a filling product or a rotary sealer for sealing filled containers, itself with receptacles for receiving one container each, wherein it can be provided to arrange a movable holding arm on the carrier, which cooperates with the receptacle configured directly on the carrier, in order to make it possible for a container to be held in the receptacle. In container treatment apparatuses with a rotary design, the carrier is also called a transport star.

Such configured carriers or transport stars, on which the receptacles are directly formed, can be found, for example, in DE 102 47 362 B4, DE 10 2004 041 724 A1 or DE 101 46 118 A1. Container treatment apparatuses that comprise a transport star with container receptacles formed directly on them have narrow shape and position tolerances, in particular with regard to the installation height of the transport star relative to upstream and downstream transport apparatuses from which containers are taken over or to which containers are transferred, and with regard to the alignment of the axis of rotation of the transport star, since even a slight deviation from the intended height of the transport star or an inclination of the transport star or of its axis of rotation to the intended alignment can result in a vertical runout of the receptacles, which in turn can prevent the containers from being taken over or transferred precisely to a transport apparatus upstream or downstream in the conveying direction of the containers or can greatly complicate the structure of the plant.

### SUMMARY

An improved clamping apparatus for holding a container in a container treatment apparatus, along with an improved container treatment apparatus are described herein according to various embodiments.

Accordingly, a clamping apparatus for holding a container in a container treatment apparatus is proposed, comprising a fixed clamping arm that comprises a connection portion for connecting the clamping apparatus to a transport unit, for example a transport star, of a container treatment apparatus. Via the connection portion, the fixed clamping arm can be attached to the transport unit in a fixed, predefined position and can likewise be removed again. In particular, via the connection region, a height position of the fixed clamping arm relative to the transport unit when connecting the fixed clamping arm to the transport unit can be predefined.

The clamping apparatus further comprises a pivotable clamping arm, which is arranged on the fixed clamping arm so as to be pivotable relative to the fixed clamping arm. The pivotable clamping arm comprises a control portion that is configured to interact with a position-specifying unit of the container treatment apparatus, in order to move the pivotable clamping arm between an opening position and a closing position. The clamping apparatus constitutes an active clamping apparatus for actively clamping and releasing a container.

By providing the actively controllable pivotable clamping arm and the fixed clamping arm, which can be firmly connected to the transport unit via its connection portion, the number of moving parts and thus also the parts subject to wear due to relative movements are reduced compared to active clamping apparatuses from the prior art with two counter-symmetrically actively pivotable clamping arms. Since the pivotable clamping arm is arranged or mounted directly on the fixed clamping arm, there is no need for a separate carrier plate on which the pivotable clamping arms in each case are pivotally mounted in active clamping apparatuses from the prior art.

In the case of container treatment apparatuses with a plurality of clamping apparatuses, fewer wearing parts have to be replaced during maintenance intervals, so that in particular their costs for replacement parts and maintenance are comparatively low compared to conventional container treatment apparatuses of the prior art.

Furthermore, the pivotable clamping arm can be aligned very easily and very precisely to the fixed clamping arm, in particular in a height direction oriented parallel to the pivot axis of the pivotable clamping arm. Accordingly, in comparison to conventional clamping apparatuses from the prior art, particularly secure clamping and correspondingly safe transport of the gripped container can be ensured in a simple manner.

According to an embodiment, the pivotable clamping arm is arranged on the fixed clamping arm so as to be pivotable in the connection portion.

The pivotable clamping arm, more precisely the control portion, is in some embodiments configured to interact with the position-specifying unit of the container treatment apparatus, in order to move a holding portion of the pivotable clamping arm between an opening position and a closing position for engagement with a container to be held.

According to one embodiment, the pivotable clamping arm can be pivoted about a pivot axis on the fixed clamping arm in the connection region. Here, the pivotable clamping arm is in various embodiments mounted on the fixed clamping arm in the connection portion by an axle element, for example a screw bolt or a guide bolt.

According to a further embodiment, the connection portion is configured in such a way that a position of the fixed clamping arm is adjustable relative to the transport unit in relation to a height direction, which is in several embodiments oriented perpendicular to the transport direction of the containers provided via the transport unit. As a result, the position of the clamping apparatus on the transport unit can be adjusted and any existing vertical runout of the transport unit can be compensated for by adjusting the height of the clamping arms on the transport unit. The fixed clamp half can easily be adjusted to the required height, at which it then remains permanently.

In the connection portion, a screw bolt configured to be coupled to the transport unit can be received in such a way that a rotational movement of the screw bolt relative to the fixed clamping arm generates a displacement of the fixed clamping arm in the height direction relative to the transport unit.

In order to protect the screw bolt from unintentional movements during operation of the container treatment plant, the clamping apparatus can comprise a securing element for securing the screw bolt against twisting, in some embodiments a lock nut or a threaded pin.

The screw bolt can comprise a guide bolt portion for guiding the fixed contact arm in the height direction relative to the transport unit. As a result, in addition to the height adjustment, guidance or mounting of the fixed contact arm and thus of the clamping apparatus relative to the transport unit can likewise be achieved. In other words, the screw bolt also constitutes a guide bolt.

In a further optional embodiment, the screw bolt serves not only for adjustment and guidance but also as a bearing, in certain embodiments a rotational bearing for the pivotable clamping arm.

According to a further embodiment, the clamping apparatus comprises in the connection region, in some embodiments, a translational guide for guiding the fixed clamping arm relative to the transport unit in the height direction.

The translational guide can have a rotation lock for preventing rotation of the fixed clamping arm relative to the transport unit, wherein the rotation lock is provided, for example, by a guide element extending in the height direction and guided by a bolt receptacle in the connection region with a non-circular cross-sectional shape, for example a polygonal cross-sectional shape, and/or the rotation lock is provided by two parallel-oriented guide elements, preferably guide bolts, each guided through a bolt receptacle in the connection region.

In order to make possible the simple and stable guidance and mounting of the fixed clamping arm and thus of the clamping apparatus on the transport unit, at least one guide bolt oriented in a height direction and received in a bolt receptacle in the connection region can be arranged in the connection portion for guiding the fixed clamping arm in the height direction relative to the transport unit and/or for adjusting the height in the height direction relative to the transport unit.

In order to achieve a particularly simple and compact structure, the pivotable clamping arm can be arranged on the fixed clamping arm so as to be pivotable via a guide bolt or screw bolt received in a bolt receptacle in the connection region. In other words, the guide bolt or screw bolt then serves multiple functional purposes. On the one hand, the guide bolt or screw bolt can provide guidance and/or height adjustment of the fixed clamping arm relative to the transport unit by the bolt and, in addition, the pivotable mounting of the pivotable clamping arm on the fixed clamping arm.

A guide bolt can be configured as a screw bolt or, conversely, can be configured in such a way that a rotational movement of the screw bolt configured as a guide bolt generates a displacement of the fixed clamping arm relative to the transport unit in the height direction, and in addition the fixed clamping arm is guided displaceably in the direction of the longitudinal axis of the guide bolt, i.e. in the height direction.

The guide bolt or screw bolt can comprise a guide surface portion that can be inserted into a guide bore on the transport unit.

The guide bolt or screw bolt can comprise at least one bearing surface portion for mounting the guide bolt in a bearing bore in the fixed clamping arm.

The guide bolt or screw bolt can comprise at least one pivot bearing surface portion for pivotably mounting the pivotable clamping arm relative to the fixed clamping arm.

Between the bolt (guide bolt or screw bolt) positioning the pivotable clamping arm on the fixed clamping arm and the pivotable clamping arm, a sleeve can be provided. The pivotable clamping arm can be mounted on a radial outer side of the sleeve, for example on a pivot bearing surface portion. For example, the sleeve and pivotable clamping arm can be connected via a press fit, in several embodiments in a rotationally fixed manner.

At least one plain bearing bushing, advantageously two plain bearing bushings, in some embodiments at least one flanged plain bushing, can be arranged in the sleeve, advantageously press-fitted. The sleeve can be rotatably mounted on the bolt (guide bolt or screw bolt) via the at least one plain bearing bushing so as to be rotatable about the pivot axis particularly smoothly. The sleeve thus provides stable mounting of the pivotable clamping arm on the fixed clamping arm, since, for example, two bearing bushings can be used and these can also be arranged in a manner spaced apart from one another at opposite ends of the sleeve in relation to the pivot axis.

In order to achieve a secure and defined holding of the container, the fixed clamping arm and the pivotable clamping arm can in each case comprise a holding portion for engagement with a container to be held, and can be configured in such a way that, in the closing position of the pivotable clamping arm, the container to be held is held by the holding portions, and in the opening position of the pivotable clamping arm, the container is released.

According to a further embodiment, the control portion comprises a guide member, for example a running roller, for interacting with a fixed guide, for example a guide rail or guide groove, of the container treatment apparatus, wherein the control portion is in several embodiments arranged on a side of the pivotable clamping arm opposite the holding portion in relation to the connection portion.

Alternatively or additionally, the control portion comprises a rotary axis element, a magnet and/or a switching bolt for moving the clamping arm between the opening position and the closing position.

The fixed clamping arm can be made from one piece.

According to an optional embodiment, the fixed clamping arm and/or the pivotable clamping arm can be configured in multiple parts.

For example, in order to be able to achieve a simple conversion from the treatment of containers of a first type to containers of a second type, a holding portion for engagement with a container to be held can be detachably arranged on a base body of the fixed clamping arm and/or a holding portion for engagement with a container to be held can be detachably arranged on a base body of the pivotable clamping arm.

A preloading apparatus can be provided in order to preload the pivotable clamping arm into the opening position or the closing position, wherein the preloading apparatus in various embodiments comprises a spring, for example a torsion spring, compression spring or tension spring, and/or at least one magnet.

Furthermore, in certain embodiments in the region of the bolt receptacle, the clamping apparatus can be designed and configured for adjusting the position of the pivotable clamping arm relative to the fixed clamping arm in the direction of the pivot axis. This height adjustment of the pivotable clamping arm relative to the fixed clamping arm can be provided, for example, by the sleeve comprising a support shoulder that supports the pivotable clamping arm in the direction of the pivot axis, and the position of the sleeve and thus of the pivotable clamping arm relative to the bolt (guide bolt or screw bolt) and/or to the fixed clamping arm can be changed by arranging at least one shim, which can be arranged on the end face of the sleeve. Optionally, at least one securing element, for example configured as a securing pin, can be provided for securing the position of the at least one shim.

A container treatment apparatus is also described according to various embodiments herein.

Accordingly, a container treatment apparatus is proposed, comprising a transport unit for transporting containers along a transport direction and at least one clamping apparatus according to one of the preceding embodiments, which is connected to the transport unit.

The advantages and effects described with regard to the clamping apparatus can be achieved in an analogous manner by the container treatment apparatus, which is why they are not repeated here in order to avoid redundancies.

### BRIEF DESCRIPTION OF THE FIGURES

Further embodiments of the invention are explained in more detail by the following description of the figures.

FIG. 1 shows a schematic perspective side view of a container treatment apparatus;

FIG. 2 shows a schematic perspective side view of a clamping apparatus of the container treatment apparatus from FIG. 1;

FIG. 3 shows a schematic perspective side view of a clamping apparatus connected to a transport unit of a container treatment apparatus according to a further embodiment;

FIG. 4 shows a schematic sectional view through the container treatment apparatus from FIG. 3;

FIG. 5 shows a schematic perspective side view of an active clamping apparatus according to a further embodiment;

FIG. 6 shows a schematic perspective side view of an active clamping apparatus according to a further embodiment;

FIG. 7 shows a schematic perspective side view of an active clamping apparatus according to a further embodiment; and

FIG. 8 shows a schematic perspective side view through the clamping apparatus from FIG. 7 in a state in which a container treatment apparatus is arranged on a transport unit.

### DETAILED DESCRIPTION

Exemplary embodiments are described below with reference to the figures. Identical, similar, or identically acting elements are provided with identical reference signs in the various figures, and a repeated description of these elements is in some cases omitted in order to avoid redundancies.

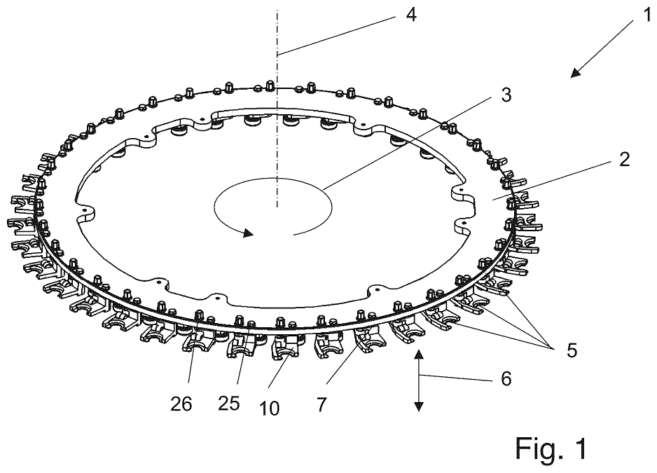

FIG. 1 shows a schematic perspective side view of a container treatment apparatus 1, which comprises a transport unit 2 for transporting containers (not shown) along a transport direction 3. In the present case, the container treatment apparatus 1 is of a rotary configuration. It accordingly comprises a transport unit 2 configured as a transport carousel or transport star. The transport direction 3 is therefore a rotational movement around a central axis of rotation 4.

A plurality of clamping apparatuses 5 are arranged on the transport unit 2 and are evenly distributed along the circumference of the transport unit 2. As described in more detail with regard to the following figures, the clamping apparatuses 5 are configured as active clamping apparatuses 5. This means they can be actively controlled between an open position and a closed position.

The clamping apparatuses 5 are adjustable on the transport unit 2 in their position relative to the transport unit 2 in a height direction 6, which here is thus oriented in the direction of the central axis of rotation 4, thus perpendicular to the transport direction 3.

As explained in more detail in the following figures, the clamping apparatus 5 comprises a fixed clamping arm 10 that, apart from the possibility of adjusting its position in the height direction 6 relative to the transport unit 2, is configured to be fixed relative to the transport unit 2. In other words, the fixed clamping arm 10 is firmly connected to the transport unit 2 via a connection portion 7 of the fixed clamping arm 10. During operation, i.e. during the treatment of containers, it cannot move relative to the transport unit 2, in particular it cannot pivot.

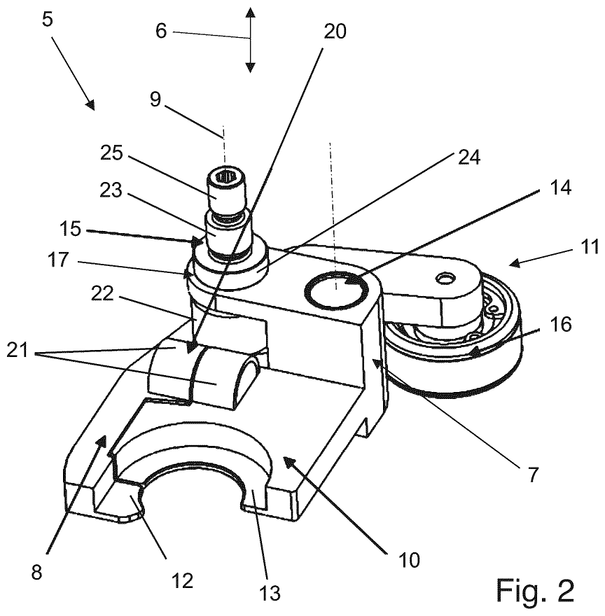

FIG. 2 shows a schematic perspective side view of the clamping apparatus 5 of the container treatment apparatus from FIG. 1. The clamping apparatus 5 comprises a fixed clamping arm 10, which has a connection portion 7 for connecting the clamping apparatus 5 to the transport unit 2.

The clamping apparatus 5 further comprises a pivotable clamping arm 8, which is arranged on the fixed clamping arm 10 in the connection region 7 so as to be pivotable relative to the fixed clamping arm 10 about a geometric pivot axis 9 oriented parallel to the height direction 6 (see FIG. 1).

For actively controlling the pivotable clamping arm 8, the latter comprises a control portion 11 that is configured to interact with a position-specifying unit (not shown here) of the container treatment apparatus 1, in order to move the pivotable clamping arm 8, more precisely a holding portion 12 for engagement with a container to be held by the pivotable clamping arm 8, between an opening position and a closing position. In FIG. 2, the pivotable clamping arm 8 or the holding portion 12 is shown in the closing position.

The fixed clamping arm 10 also has a holding portion 13 for engagement with a container to be held. The holding portion 13 is arranged at a predefined distance from the connection portion 7 on the fixed clamping arm 10.

The holding portions 12, 13 are configured in such a way that in the closing position of the pivotable clamping arm 8, the container to be held is held by the holding portions 12, 13, and in the opening position of the pivotable clamping arm 8, the container is released.

The control portion 11 comprises a guide member in the form of a running roller 16 for interacting with a fixed guide (not shown), for example a guide rail or guide groove, of the container treatment apparatus 1.

Alternatively, the pivotable clamping arm 8 can also be moved between the opening position and the closing position via a magnet, rotary axis element or control cam (not shown here) encompassed by the control portion.

The control portion 11 is arranged on a side of the pivotable clamping arm 8 opposite the holding portion 12 in relation to the connection portion 7.

In order to preload the pivotable clamping arm 8 into a predefined position, here into the closing position, the clamping apparatus 5 comprises a preloading apparatus 20 for preloading the pivotable clamping arm 8. The preloading apparatus 20 comprises two mutually attracting magnets 21, wherein one of the magnets 21 is firmly arranged on the pivotable clamping arm 8 and the other magnet 21 is firmly arranged on the fixed clamping arm 10, in each case spaced apart from the pivot axis 9.

Accordingly, the pivotable clamping arm 8 can be pivoted from the closing position into the opening position by actuating the control portion 11.

For connecting the clamping apparatus 5 to the transport unit 2, the fixed clamping arm in the connection portion 7 has a first bolt receptacle 14 for receiving a guide bolt 25 fixed to the transport unit 2 (see FIG. 1). The guide bolt 25 is guided in the first bolt receptacle 14 so that it can be displaced in the height direction 6.

In the connection portion 7, a second bolt receptacle 17 is also arranged, spaced apart from the first bolt receptacle 14, in which a screw bolt 15 is received so as to be rotatable about the pivot axis 9. The screw bolt 15 is received in the second bolt receptacle 17 so as to prevent it from being displaced in the direction of the pivot axis 9, i.e. in the direction of the longitudinal axis of the screw bolt 15. The second bolt receptacle 17 thus constitutes a fixed bearing for the screw bolt 15 relative to the fixed clamping arm 10.

The screw bolt 15 also provides the pivot axis 9 for the pivotable clamping arm 8. For this purpose, the screw bolt 15 comprises a pivot bearing surface portion 22 for pivotally mounting the pivotable clamping arm 8 relative to the fixed clamping arm 10.

For the height adjustment of the clamping apparatus 5 relative to the transport unit 2, the screw bolt 15 comprises a first threaded portion 23, which can be screwed into a correspondingly structured threaded portion (not shown here) provided in the transport unit 2. The screw-in depth of the first threaded portion 23 into the correspondingly structured threaded portion serves as a specification for the position of the fixed clamping arm 10 and thus of the entire clamping apparatus 5 relative to the transport unit 2.

The screw bolt 15 further comprises a guide surface portion 24 that can be inserted into a guide bore on the transport unit 2.

As a result, the fixed clamping arm is guided by the screw bolt 17, more precisely by its guide surface portion 24, and the guide bolt guided in the first bolt receptacle 14, so as to be displaceable in the height direction 6 relative to the transport unit 2 in a rotationally secure manner.

The screw bolt 15 further comprises a second threaded portion 25 onto which a lock nut 26 (see FIG. 1), not shown here, can be screwed from a side of the transport unit 2 opposite the fixed clamping arm 10. The lock nut 26 can be screwed on with a predefined torque, wherein the lock nut 26 is supported on the transport unit 2. As a result, the screw bolt 15 on the transport unit 2 is in a clamped state in which it is secured against unintentional twisting. Accordingly, the clamping apparatus 1 is secured against an unintentional adjustment of its position in the height direction 6 relative to the transport unit 2.

The fixed clamping arm is made in one piece. Thus, the holding portion 13 and the connection portion 7 constitute parts of a one-piece component.

Alternatively, the holding portion 13 can also be arranged as a separate part, in some embodiments detachably, on the fixed clamping arm 10 and/or the holding portion 12 can be arranged as a separate part, in various embodiments detachably, on the pivotable clamping arm 8.

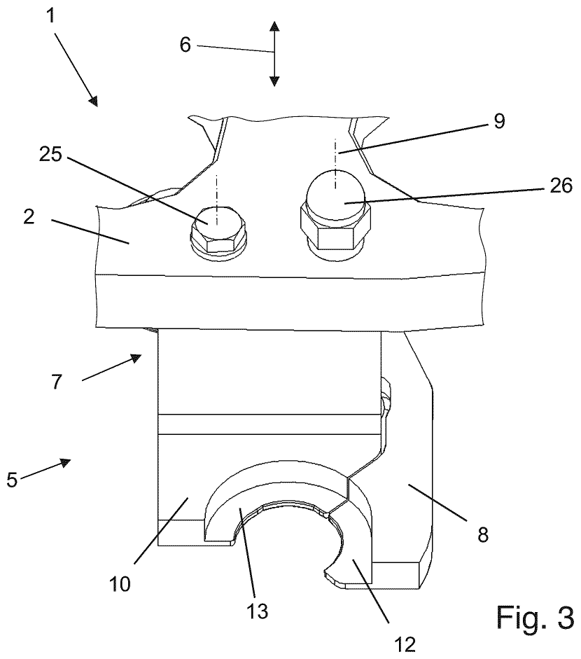

FIG. 3 shows a schematic perspective side view of a clamping apparatus 5 according to a further embodiment, which in turn is arranged on a transport unit 2 analogously to the container treatment apparatus 1 from FIG. 1.

The clamping apparatus 5 substantially corresponds to that shown in FIG. 1, wherein, here, the position of the screw bolt 15 and the guide bolt 25 are reversed. In addition, the preloading apparatus 20 comprises a tension spring element, here concealed by the clamping arms 8, 10, which preloads the pivotable clamping arm 8 into the closing position. For hygienic reasons, the tension spring element is arranged here under the fixed clamping arm 10.

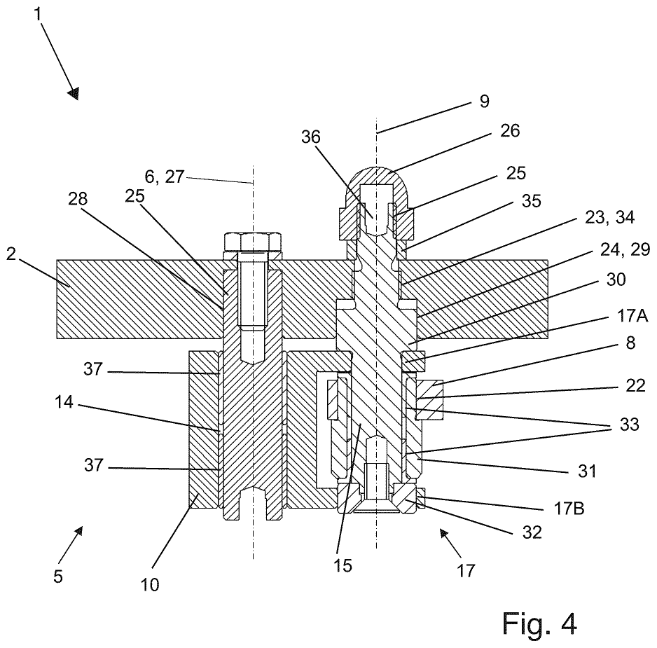

FIG. 4 shows a schematic sectional view through the container treatment apparatus 1 from FIG. 3 by a guide axis 27 of the guide bolt 25 arranged parallel to the pivot axis 9 and parallel to and spaced apart from the pivot axis.

It can be seen that the guide bolt 25 is received in a receiving bore 28 in the transport unit 2 and is screwed to the upper side of the transport unit 2.

The guide bolt 25 is guided in the first bolt guide 14 via two plain bushings 37 relative to the fixed clamping arm 10. The plain bushings 37 are in certain embodiments each arranged in the bolt guide via a press fit.

It can also be seen that the screw bolt 15 with its guide surface portion 24 is fitted into a guide bore 29 of the transport unit 2.

The screw bolt 15 is received in the connection region 7 on the fixed clamping arm 10 in a second bolt receptacle 17, which is divided into a fixed bearing bore 17A providing a fixed bearing for the screw bolt 15 and a floating bearing bore 17B providing a floating mounting for the screw bolt 15.

The fixed mounting of the screw bolt 15 is achieved in that the screw bolt is axially supported on one side of the fixed bearing bore 17A with a shoulder 30, and on the other side of the fixed bearing bore 17A is clamped against the fixed clamping arm 10 by a sleeve 31 and a clamping unit 32 via two flanged plain bushings 33.

The sleeve 31 comprises the pivot bearing surface portion 22 for pivotally mounting the pivotable clamping arm 8 relative to the fixed clamping arm 8.

The first threaded portion 23 of the screw bolt 15 is screwed into the correspondingly structured threaded portion 34 in the transport unit 2.

Furthermore, the lock nut 26 is screwed onto the second threaded portion 25 and tightened with a predefined torque, so that the first threaded portion 23 and the second threaded portion 25 are then clamped against one another.

A sealing washer 35 is optionally provided between the lock nut 26 and the transport unit 2.

For setting the height of the clamping apparatus 5 relative to the transport unit 2, the lock nut 26 must initially be loosened. The screw bolt 15 can then be rotated around the pivot axis 9. For this purpose, the screw bolt 15 comprises a tool holder 36.

Since the pivotable clamping arm 8 is mounted so as to be rotatable relative to the screw bolt 15 and the screw bolt 15 is secured against axial displacement on the fixed clamping arm 10, a rotation of the screw bolt 15 about the pivot axis 9 has no influence on the position of the pivotable clamping arm 8.

Since the screw bolt 15 is secured against axial displacement on the fixed clamping arm 10 by the fixed bearing on the fixed bearing bore 17A described above, the fixed clamping arm 10, which is guided displaceably in the height direction 6 via the guide bolt 25 and the screw bolt, and thus the clamping apparatus 5, undergoes an offset in the height direction 6 upon rotation of the screw bolt 15, which offset is proportional to the total angle of the rotational movement of the screw bolt 15 about the pivot axis 9.

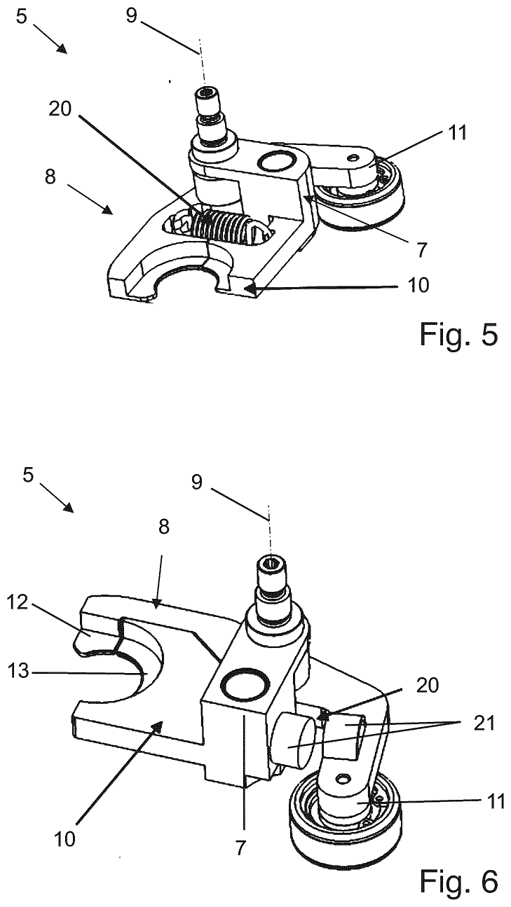

FIG. 5 shows a schematic perspective side view of an active clamping apparatus 5 according to a further embodiment, which substantially corresponds to that of FIGS. 1 and 2. The preloading apparatus 20 is configured here analogously to the embodiment in FIG. 3 by a spring element 37, which is arranged at one end on the fixed clamping arm 10 and at the other end on the pivotable clamping arm 8 spaced apart from the pivot axis 9.

FIG. 6 shows a schematic perspective side view of an active clamping apparatus 5 according to a further embodiment, which substantially corresponds to that of FIGS. 1 and 2. The preloading apparatus 20 is arranged here in relation to the connection region 7 or the pivot axis 9 on the side of the control portion 11, thus opposite the holding portions 12, 13.

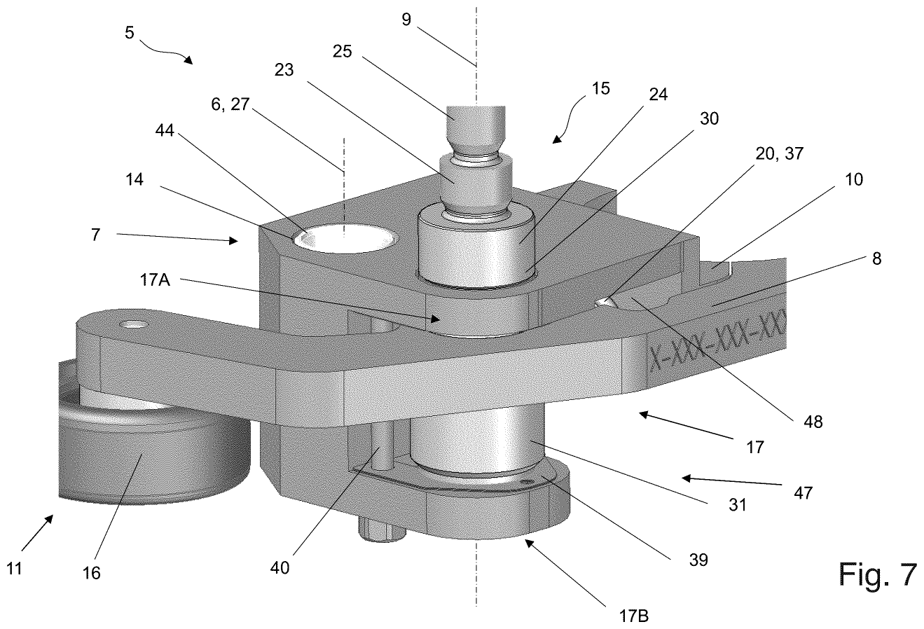

FIG. 7 shows a schematic perspective side view of an active clamping apparatus 5 according to a further embodiment, which substantially corresponds to that of FIGS. 3 and 4. Analogous to the embodiments according to FIGS. 3 and 5, the clamping apparatus 5 comprises a preloading apparatus 20 in the form of a spring element 37. The preloading apparatus 20, specifically here the spring element 37, is received in a receiving space 48 in the connection portion 7 and is thus covered from above. Consequently, contamination of the preloading apparatus 20, here the spring element 37 or, in an alternative embodiment, one or more magnets 21 (see FIG. 6), by the product to be filled can be prevented in order to prevent germ formation on the preloading apparatus 20, which is difficult to clean. Furthermore, this can prevent fragments of the spring element 37 from being thrown in the direction of the container to be transported in the event of a spring break.

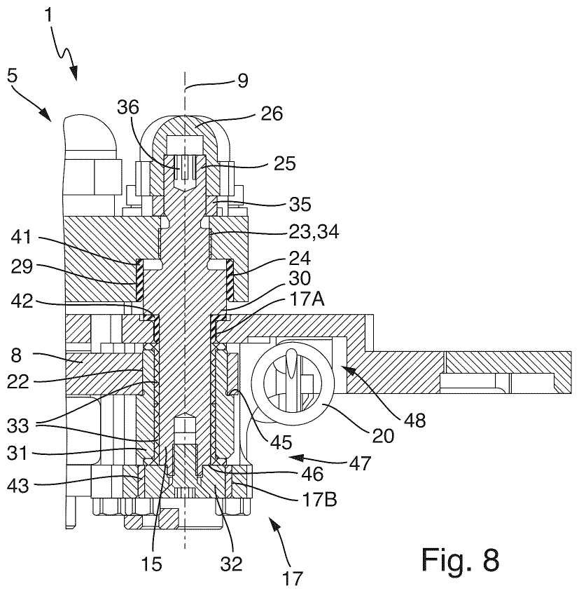

FIG. 8 shows a schematic sectional view through the clamping apparatus 5 from FIG. 7 in a state attached to the transport unit 2. The structure of the clamping apparatus 5 shown here substantially corresponds to that described in FIG. 4. In order to prevent seizing during height setting or disassembly, plain bushings 41-44 are provided. The plain bushing 44 is provided in the bolt receptacle 24. The plain bushing 41 supports the relative movement of the screw bolt 15 relative to the transport unit 2. For this purpose, it is provided between the guide surface portion 24 and the guide bore 29. Analogously, the plain bushing 42 is provided between the screw bolt 15 and the fixed bearing bore 17A, wherein a flange portion of the plain bushing 42 provides a sliding of the shoulder 30. The plain bushing 43 is arranged between the clamping unit 32 and the floating bearing portion 17B.

In contrast to the formation according to FIG. 4, in the embodiment shown in FIG. 8, the clamping unit 32 can be clamped against an end-face stop 46 on the screw bolt 15. In other words, the clamping unit 32 here constitutes a cover that is clamped against the bolt 15 by screwing it on, which prevents the bolt 15 from being pulled out. The sleeve 31 is thus not clamped between the fixed bearing portion encompassing the fixed bearing bore 17A and the screw bolt 15, but is unclamped in the direction of the pivot axis 9. Here, the distance between the fixed bearing portion and the floating bearing portion comprising the floating bearing bore 17B in the direction of the pivot axis 9 is greater by a predefined amount than the length in the direction of the pivot axis 9, which results for the assembly from the sleeve 31 and the two flanged plain bushings 33. The flanged plain bushings are in some embodiments connected to the sleeve 31 via a press fit.

For setting the height position of the pivotable clamping arm 8 relative to the fixed clamping arm 10 in the direction of the pivot axis 9, at least one height adjustment element, for example one or more shims, can be inserted between the flanged plain bushing 33 aligned with the clamping unit 32 and the clamping unit 32 until the pivotable clamping arm 8 is correctly positioned relative to the fixed clamping arm 10 when viewed in the direction of the pivot axis 9, more precisely, until the holding portions 12, 13 of the clamping arms 8, 10 are in the same position in the direction of the pivot axis 9.

In order to make it possible for the container to be held as accurately and stably as possible in the clamping apparatus 5, the pivotable clamping arm 8 can be displaced relative to the fixed clamping arm 10 in the direction of the pivot axis 9, within the limits determined by the difference in the distance between the bearing portions 17A, 17B and the length of the above-mentioned assembly. Accordingly, it is possible to bring the clamping arms 8, 10 very precisely at the same height as viewed in the direction of the pivot axis 9. Accordingly, the holding portions 12, 13 can be aligned flush with one another even if manufacturing tolerances exist.

The height of the pivotable clamping arm 8 is predefined by the distance in the direction of the pivot axis 9 between the lower end face of the lower flanged plain bushing 31 on the floating bearing aide and a support shoulder 45 on which the pivotable clamping arm 8 rests, as in the embodiment according to FIG. 4. In order to change the position of the pivotable clamping arm 8 relative to the fixed clamping arm 10, the sleeve can be lifted in the direction of the fixed bearing bore 17A until the holding portions 12, 13 are flush as seen in the direction of the pivot axis 9. The resulting gap between the end face of the flanged plain bushing 31 on the floating bearing side and the floating bearing portion encompassing the floating bearing bore 17B is filled by inserting one or more U-shaped shims 39 (see FIG. 7). Similarly, if there is a gap (which still exists) between the end face of the flanged plain bushing 31 on the fixed bearing side and the fixed bearing portion comprising the fixed bearing bore 17A, this gap can also be filled by at least one further shim 39 inserted into such gap. Accordingly, the sleeve 31 is then located in the bolt receptacle 17 substantially free of play in relation to the direction of the pivot axis 9.

The one or more shims 39 are inserted laterally and then fixed in position by at least one securing pin 40, in this case two securing pins 40.

The sleeve 31 and the shims 39 thus provide a height adjustment apparatus 47 of the pivotable clamping arm 8 relative to the fixed clamping arm 10, which optionally comprises at least one securing element, here configured as a securing pin 40, and/or at least one flange plain bushing 33.

To the extent applicable, any of the individual features set forth in the exemplary embodiments may be combined and/or interchanged, without departing from the scope of the invention.

1-15. (canceled)

16. A clamping apparatus for holding a container in a container treatment apparatus, comprising:
a fixed clamping arm comprising a connection portion configured to connect the clamping apparatus to a transport unit of the container treatment apparatus; and
a pivotable clamping arm arranged on the fixed clamping arm so as to be pivotable relative to the fixed clamping arm, wherein the pivotable clamping arm comprises a control portion configured to interact with a position-specifying unit of the container treatment apparatus to enable the pivotable clamping arm to be moved between an opening position and a closing position.

17. The clamping apparatus of claim 16, wherein:
the pivotable clamping arm is arranged on the fixed clamping arm so as to be pivotable in the connection portion, and/or
the control portion is configured to interact with the position-specifying unit of the container treatment apparatus to enable a holding portion of the pivotable clamping arm to be moved between the opening position and the closing position for engagement with the container.

18. The clamping apparatus of claim 16, wherein:
the pivotable clamping arm on the fixed clamping arm in the connection portion is pivotable about a pivot axis, and
the pivotable clamping arm is mounted on the fixed clamping arm in the connection portion by an axle element.

19. The clamping apparatus of claim 18, wherein the axle element comprises a screw bolt or a guide bolt.

20. The clamping apparatus of claim 16, wherein:
the connection portion is configured in such a way that a position of the fixed clamping arm in relation to a height direction that is oriented perpendicular to a transport direction of a container provided via the transport unit is adjustable relative to the transport unit, and
a screw bolt configured to be coupled to the transport unit is received in the connection portion in such a way that a rotational movement of the screw bolt relative to the fixed clamping arm generates a displacement of the fixed clamping arm in the height direction relative to the transport unit.

21. The clamping apparatus of claim 20, further comprising a securing element configured to secure the screw bolt against rotation, wherein the screw bolt comprises a guide surface portion configured to guide the fixed clamping arm in the height direction relative to the transport unit.

22. The clamping apparatus of claim 21, wherein the securing element comprises a lock nut or a threaded pin.

23. The clamping apparatus of claim 20, further comprising a translational guide in the connection portion that is configured to guide the fixed clamping arm relative to the transport unit in the height direction, wherein the translational guide comprises a rotation lock configured to prevent rotation of the fixed clamping arm relative to the transport unit.

24. The clamping apparatus of claim 23, wherein:
the rotation lock comprises a guide element extending in the height direction and guided by a bolt receptacle in the connection portion with a non-circular cross-sectional shape, and/or
the rotation lock comprises two parallel-oriented guide elements, each guide element guided through a bolt receptacle in the connection portion.

25. The clamping apparatus of claim 24, wherein the two parallel-oriented guide elements each comprise a guide bolt.

26. The clamping apparatus of claim 25, wherein at least one guide bolt is oriented in the height direction and received in a bolt receptacle in the connection portion, and is arranged to enable guiding the fixed clamping arm in the height direction relative to the transport unit and/or adjusting a height in the height direction relative to the transport unit.

27. The clamping apparatus of claim 25, wherein:
at least one guide bolt is configured as a screw bolt in such a way that a rotational movement of the screw bolt generates a displacement of the fixed clamping arm relative to the transport unit in the height direction, and/or
at least one guide bolt comprises a guide surface portion is insertable into a guide bore on the transport unit, at least one bearing surface portion configured to mount the at least one guide bolt in a bearing bore in the fixed clamping arm, and/or at least one pivot bearing surface portion configured to pivotably mount the pivotable clamping arm relative to the fixed clamping arm.

28. The clamping apparatus of claim 16, wherein the pivotable clamping arm is arranged on the fixed clamping arm so as to be pivotable via a guide bolt or a screw bolt received in a bolt receptacle in the connection portion.

29. The clamping apparatus of claim 16, wherein:
the fixed clamping arm and the pivotable clamping arm each comprise a holding portion configured to engage with the container, and
each holding portion is configured in such a way that, in the closing position of the pivotable clamping arm, the container is held by the holding portions, and in the opening position of the pivotable clamping arm, the container is released.

30. The clamping apparatus of claim 16, wherein:
the control portion comprises a guide member configured to interact with a fixed guide of the container treatment apparatus,
the control portion is arranged on a side of the pivotable clamping arm opposite a holding portion in relation to the connection portion, and/or
the control portion comprises a rotary axis element, a magnet and/or a switching bolt configured to move the pivotable clamping arm between the opening position and the closing position.

31. The clamping apparatus of claim 16, wherein the fixed clamping arm is formed from one piece.

32. The clamping apparatus of claim 16, wherein:
the fixed clamping arm and/or the pivotable clamping arm are formed in multiple parts,
a holding portion configured to engage with the container is detachably arranged on a base body of the fixed clamping arm, and/or
a holding portion configured to engage with the container is detachably arranged on a base body of the pivotable clamping arm.

33. The clamping apparatus of claim 16, further comprising a preloading apparatus configured to preload the pivotable clamping arm into the opening position or the closing position.

34. The clamping apparatus of claim 33, wherein the preloading apparatus comprises a torsion spring, a compression spring or a tension spring, and/or at least one magnet.

35. A container treatment apparatus, comprising
a transport unit configured to transport containers along a transport direction; and
a clamping apparatus connected to the transport unit, wherein the clamping apparatus comprises:
a fixed clamping arm comprising a connection portion configured to connect the clamping apparatus to a transport unit of the container treatment apparatus; and
a pivotable clamping arm arranged on the fixed clamping arm so as to be pivotable relative to the fixed clamping arm, wherein the pivotable clamping arm comprises a control portion configured to interact with a position-specifying unit of the container treatment apparatus to enable the pivotable clamping arm to be moved between an opening position and a closing position.
